(19) United States
(12) Patent Application Publication
(10) Pub. No.: US 2024/0041039 A1
(43) Pub. Date: Feb. 8, 2024

(54) COMPOSITIONS AND METHODS FOR CONTROLLING PLANT PATHOGENS INCLUDING NEMATODES

(71) Applicant: Kannar Earth Science, Ltd., Lawrenceville, GA (US)

(72) Inventors: Samuel L. Cloete, Suwanee, GA (US); Ahsan Habib, Tucker, GA (US); Heather Lewis, Duluth, GA (US); Justin Kwiatkowski, Atlanta, GA (US)

(21) Appl. No.: 18/228,237

(22) Filed: Jul. 31, 2023

Related U.S. Application Data
(60) Provisional application No. 63/370,152, filed on Aug. 2, 2022.

(51) Int. Cl. A01N 43/16; A01P 5/00; A01P 7/04; A01P 3/00; A01N 43/90

(52) U.S. Cl. CPC A01N 43/16; A01P 5/00; A01P 7/04; A01P 3/00; A01N 43/90

(57) ABSTRACT

Compositions are provided that include: (i) baicalin, or mangiferin and swertiamarin, or mangiferin and hesperidin; (ii) glutathione; and (iii) chitosan. The compositions can kill root knot nematodes within a few seconds of contact and kill larvae of the insects of Coleoptera within 3-18 minutes. Seed treatment with the compositions in combination with a commercial chemical fungicide resulted in enhanced antifungal activity and improved seedling germination and early root growth. Liquid application of the compositions to soil in a greenhouse pot assay with soybean seedlings can result in fewer nematode eggs relative to an industry standard chemical nematicide and application of the compositions to soil in furrow can enhance corn yield relative to a commercial chemical nematicide.

### CROSS-REFERENCE TO RELATED APPLICATIONS

This application claims priority to U.S. Provisional Patent Application No. 63/370,152 filed on Aug. 2, 2022, which is incorporated by reference herein in its entirety.

### TECHNICAL FIELD

The present disclosure relates to controlling agricultural pests to reduce crop damage and subsequent loss of significant yield. Specifically, the present disclosure relates to control of parasitic nematodes, rootworms and fungi in soil or any other growing media where plants are grown, using natural compounds.

### BACKGROUND

Nematodes are voracious soil residents that are parasitic to almost all plants on land. Plant Parasitic nematodes (PPNs), cause an estimated yearly loss of yields over $100 billion (Thoden et al., 2011). Most common PPNs include root knot, cyst, ring, reniform, sting, stubby-root, and lesion nematodes. It is almost impossible to eliminate PPNs from soil. Another significant threat for major crop is rootworm and wireworm. The loss of corn is about 15%, leading to over $1B for losses and added production cost (Metcalf, 1986). According to Kruger Seeds, an Iowa-based seed company, indicated that a 15% loss is evident under moderate levels of rootworm infestation which lowers expected potential yield of 200 bu/acre to 30 bu/acre (Kruger Seeds, 2018). While pests in the rhizosphere soil damage major field crops, there are also seed borne pathogens that prevent healthy seed germination and emergence. For example, seed borne fungal, bacterial, and viral pathogens are a major concern for high value vegetable seeds. Phytophthora, Fusarium, Pythium, Rhizoctonia, and other pathogens damage germinating seedlings and subsequent seedling growth in tomatoes and peppers.

As there is always pest pressure for crops grown in fields or greenhouses, several measures can help farmers reduce pest infestation to a considerable extent. These strategies include chemical nematicides, agronomic practices (crop rotation, cover crops or bio-fumigation), biopesticides (fungi, bacteria, or their derivatives), and plant derived formulations (Nicola et al., 2021). Despite these strategies, current management practices are not enough to significantly reduce nematodes, rootworms and seed-borne fungal, bacterial and virus infestation. Furthermore, use of chemical pesticides has been limited in recent years due to the adverse effect on the environment (Fereidoun and Abolfazl, 2020) and chemical residue contamination of foods. In recent years, biopesticides have received significant attention owing to their safety profiles and ease of application, but formulation stability, compatibility and on-seed survival of the active organism have limited such product development (Abd-Elgawad, 2016).

There remains an urgent need for agronomically durable, sustainable, and economically feasible alternatives to toxic chemical control of plant pests. The present disclosure provides such alternatives.

### SUMMARY

In one embodiment, a pesticide composition is provided that includes (i) baicalin; (ii) chitosan; and (iii) glutathione. The components (i)-(iii) are present in the composition in an amount suitable to improve one or both of plant growth and health in the presence of one or more plant pathogens. The components (i)-(iii) can be present in the composition in a ratio by weight of: (i) about 0.02 to about 0.08% baicalin; (ii) about 0.025 to about 0.1% chitosan; and (iii) about 0.01 to about 0.04% glutathione.

In another embodiment, a pesticide composition is provided that includes (i) mangiferin, (ii) swertiamarin, (iii) chitosan, and (iv) glutathione. The components (i)-(iv) are present in the composition in an amount suitable to improve one or both of plant growth and health in the presence of one or more plant pathogens. The components (i)-(iv) can be present in the composition in a ratio by weight of: (i) about 0.01 to about 0.1% mangiferin; (ii) about 0.01 to about 0.05% swertiamarin; (iii) about 0.05 to about 0.1% chitosan; and (iv) about 0.01 to about 0.04% glutathione.

In yet another embodiment, a pesticide composition is provided that includes (i) mangiferin, (ii) hesperidin, (iii) chitosan, and (iv) glutathione. The components (i)-(iv) are present in the composition in an amount suitable to improve one or both of plant growth and health in the presence of one or more plant pathogens. The components (i)-(iv) can be present in the composition in a ratio by weight of: (i) about 0.02 to about 0.1% mangiferin; (ii) about 0.02 to about 0.1% hesperidin; (iii) about 0.025 to about 0.1% chitosan; and (iv) about 0.01 to about 0.04% glutathione.

In one instance, a liquid flowable pesticide composition is provided that includes: (i) baicalin in the range from 0.1 to 1.0 g/L; (ii) chitosan in the range from 0.5 to 1.0 g/L; and (iii) glutathione in the range from 0.1 to 1.0 g/L.

In another instance, a liquid flowable pesticide composition is provided that includes: (i) mangiferin in the range from 0.1 to 1.0 g/L; (ii) swertiamarin, in the range of 0.1-0.5 g/L, (iii) chitosan in the range from 0.5 to 1.0 g/L; and (iv) glutathione in the range from 0.1 to 1.0 g/L.

In yet another instance, a liquid flowable pesticide composition is provided that includes: (i) mangiferin in the range from 0.1 to 1.0 g/L; (ii) hesperidin in the range of 0.1-0.5 g/L, (iii) chitosan in the range from 0.5 to 1.0 g/L; and (iv) glutathione in the range from 0.1 to 1.0 g/L.

The compositions of the present disclosure can be formulated as a dry powder or as a flowable liquid.

The compositions of the present disclosure can further include a cellulose-based polymer. The cellulose-based polymer can include hydroxyethycellulose.

In one instance, the composition is formulated as a dry powder, wherein the components (i)-(iii) in the composition are present in a ratio by weight of: (i) about 0.02 to about 0.08% baicalin; (ii) about 0.025 to about 0.1% chitosan; and (iii) about 0.01 to about 0.04% glutathione.

In another instance, the composition is formulated as a flowable liquid, wherein the total amount of component baicalin is in the range from 0.1 to 1.0 g/L, the total amount of component chitosan is in the range from 0.5 to 1.0 g/L, and the total amount of component glutathione is in the range from 0.1 to 1.0 g/L.

In addition to the ready to use compositions described above, the present disclosure also includes concentrated versions of these compositions that can be diluted with water prior to use. By way of non-limiting example, the compositions can be provided as 2-fold, 5-fold, 10-fold, 50-fold, 100-fold or more concentrates for dilution to the RTU concentration prior to use.

In another embodiment, a plant seed is provided that is coated with a composition of the present disclosure, wherein the components are present in the composition on the coated seed in an amount suitable to improve one or both of plant growth and health in the presence of one or more plant pathogens. The composition can include: (i) baicalin, or mangeferin and swertiamarin, or mangiferin and hesperidin; (ii) chitosan; and (iii) glutathione, wherein the components (i)-(iii) are present in the composition on the coated seed in an amount suitable to improve one or both of plant growth and health in the presence of one or more plant pathogens. The components (i)-(iii) can be present in the composition on the coated seed in a ratio by weight of: (a) about 0.02 to about 0.08% baicalin, about 0.025 to about 0.1% chitosan; and about 0.01 to about 0.04% glutathione; (b) about 0.01 to about 0.1% mangiferin, about 0.01 to about 0.05% swertiamarin, about 0.05 to about 0.1% chitosan, and about 0.01 to about 0.04% glutathione; or (c) about 0.02 to about 0.1% mangiferin, about 0.02 to about 0.1% hesperidin, about 0.025 to about 0.1% chitosan, and about 0.01 to about 0.04% glutathione.

In various instances, a method is provided of plant seed treatment including: applying to seeds of a plant a coating of a composition of the present disclosure, wherein the components are present in the composition on the coated seed in an amount suitable to improve one or both of plant growth and health in the presence of one or more plant pathogens. The composition can include: (i) baicalin, or mangeferin and swertiamarin, or mangiferin and hesperidin; (ii) chitosan; and (iii) glutathione, wherein the components (i)-(iii) are present in the composition on the coated seed in an amount suitable to improve one or both of plant growth and health in the presence of one or more plant pathogens. The components (i)-(iii) can be present in the composition on the coated seed in a ratio by weight of: (a) about 0.02 to about 0.08% baicalin, about 0.025 to about 0.1% chitosan; and about 0.01 to about 0.04% glutathione; (b) about 0.01 to about 0.1% mangiferin, about 0.01 to about 0.05% swertiamarin, about 0.05 to about 0.1% chitosan, and about 0.01 to about 0.04% glutathione; or (c) about 0.02 to about 0.1% mangiferin, about 0.02 to about 0.1% hesperidin, about 0.025 to about 0.1% chitosan, and about 0.01 to about 0.04% glutathione.

In other instances, a method is provided for improving plant growth and/or health including: planting a plant or a seed of a plant in a suitable growth medium, the plant or the seed having a coating or partial coating of a composition of the present disclosure, wherein the components are present in the composition on the coated plant or seed in an amount suitable to improve one or both of plant growth and health in the presence of one or more plant pathogens. The composition can include: (i) baicalin, or mangeferin and swertiamarin, or mangiferin and hesperidin; (ii) chitosan; and (iii) glutathione, wherein the components (i)-(iii) are present in the composition on the coated plant or seed in an amount suitable to improve one or both of plant growth and health in the presence of one or more plant pathogens. The components (i)-(iii) can be present in the composition on the plant or the seed in a ratio by weight of: (a) about 0.02 to about 0.08% baicalin, about 0.025 to about 0.1% chitosan; and about 0.01 to about 0.04% glutathione; (b) about 0.01 to about 0.1% mangiferin, about 0.01 to about 0.05% swertiamarin, about 0.05 to about 0.1% chitosan, and about 0.01 to about 0.04% glutathione; or (c) about 0.02 to about 0.1% mangiferin, about 0.02 to about 0.1% hesperidin, about 0.025 to about 0.1% chitosan, and about 0.01 to about 0.04% glutathione.

In some embodiments, a method is provided for improving plant growth and/or health including: delivering to seed of a plant, foliage of a plant, roots of a plant, or soil or growth medium surrounding a plant, a composition of the present disclosure, wherein the components are present in the composition in an amount suitable to improve one or both of plant growth and health in the presence of one or more plant pathogens. The composition can include: (i) baicalin, or mangeferin and swertiamarin, or mangiferin and hesperidin; (ii) chitosan; and (iii) glutathione, wherein the components (i)-(iii) are present in the composition in an amount suitable to improve one or both of plant growth and health in the presence of one or more plant pathogens. The components (i)-(iii) can be present in the composition in a ratio by weight of: (a) about 0.02 to about 0.08% baicalin, about 0.025 to about 0.1% chitosan; and about 0.01 to about 0.04% glutathione; (b) about 0.01 to about 0.1% mangiferin, about 0.01 to about 0.05% swertiamarin, about 0.05 to about 0.1% chitosan, and about 0.01 to about 0.04% glutathione; or (c) about 0.02 to about 0.1% mangiferin, about 0.02 to about 0.1% hesperidin, about 0.025 to about 0.1% chitosan, and about 0.01 to about 0.04% glutathione.

The one or more plant pathogens can be, but are not limited to, one or a combination of nematodes, fungi, or rootworms.

In one embodiment of the present invention, the components in the compositions of the present disclosure are present in an amount sufficient to provide synergistic activity against nematodes.

The seed or plant can include a monocot or a dicot. The seed or plant can include, but is not limited to, corn, soybean, cotton, peanut, wheat, rice, sorghum, canola, chickpea, lentil, potato, tomato, eggplant, cucumber, or squash. The seed or plant can include a legume or a non-legume.

### BRIEF DESCRIPTION OF THE DRAWINGS

The features and advantages of the present invention will be more clearly understood from the following description taken in conjunction with the accompanying drawings. The accompanying Figures are provided by way of illustration and not by way of limitation. The foregoing aspects and other features of the disclosure are explained in the following description, taken in connection with the accompanying example figures (also “FIG.”) relating to one or more embodiments.

FIG. 1A is a photograph showing root-knot nematodes swimming in water before addition of a formulation including baicalin, chitosan, and glutathione.

FIG. 1B is a photograph showing dead root-knot nematodes in water 10-30 seconds after addition of a formulation including baicalin, chitosan, and glutathione.

FIG. 2A is a photograph showing a live mealworm prior to treatment with a liquid formulation including baicalin, chitosan, and glutathione.

FIG. 2B is a photograph showing a dead mealworm within 5 minutes after treatment with a liquid formulation including baicalin, chitosan, and glutathione.

FIG. 2C is a photograph showing a live superworm prior to treatment with a liquid formulation including baicalin, chitosan, and glutathione.

FIG. 2D is a photograph showing a dead superworm within 25 minutes after treatment with a liquid formulation including baicalin, chitosan, and glutathione.

FIG. 3A is a graph showing the effect of a formulation including baicalin, chitosan, and glutathione (Baicalin-based BP) on Southern Root Knot nematode control in a greenhouse pot assay as compared to positive control commercial synthetic pesticide Ilevo from Bayer, Inc. (Ilevo) and negative control where no nematode eggs were added to the pots (CHK).

FIG. 3B is a graph showing the effect of a formulation including baicalin, chitosan, and glutathione (Baicalin-based BP) on Southern Root Knot nematode control in a greenhouse pot assay as compared to positive control commercial synthetic pesticide Ilevo from Bayer, Inc. (Ilevo) and negative control where no nematode eggs were added to the pots (CHK).

FIG. 4A is a photograph showing antifungal (F. oxysporum) activity represented by zone of inhibition (ZOI) on a Petri plate for the commercial pesticide Rancona VPD (UPL, Ltd.).

FIG. 4B is a photograph showing antifungal (F. oxysporum) activity represented by zone of inhibition (ZOI) on a Petri plate for a formulation of the present disclosure including baicalin, chitosan, and glutathione.

FIG. 5A is a photograph showing germination of peanut seeds treated with UPL, Ltd.'s Rancona VPL pesticide alone.

FIG. 5B is a photograph showing germination of peanut seeds treated with UPL, Ltd.'s Rancona VPL pesticide in combination with a composition including baicalin, chitosan, and glutathione of the present disclosure. The combination of Rancona VPL pesticide with the baicalin-based composition of the present disclosure showed better control of contamination (see arrows pointing to contamination in the tray in FIG. 5A) and better seedling germination and early root growth as can be seen in the tray in FIG. 5B.

FIG. 6 is a graph showing corn yield enhancement in a field trial by the mangiferin-hesperidin-based composition of the present disclosure (Mangiferin-Hesperidin-based BP) as compared to the industry-standard synthetic nematicide Vydate SL from UPL (Vydate SL) and untreated control (Untreated Check). The yield increase for the mangiferin-hesperidin-based composition was 43.8 bu/A over untreated control and 18.5 bu/A over Vydate SL.

### DETAILED DESCRIPTION

To promote an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Unless otherwise indicated, technical and scientific terms used herein have the same meaning as commonly understood by those of ordinary skill in the art to which this disclosure belongs.

Following long-standing patent law convention, the terms “a,” “an,” and “the” refer to “one or more” when used in this application, including the claims. Thus, for example, reference to “a seed” includes a plurality of seeds, unless the context clearly is to the contrary, and so forth.

Throughout this specification and the claims, the terms “comprise,” “comprises,” and “comprising” are used in a non-exclusive sense, except where the context requires otherwise. Likewise, the terms “having” and “including”, and their grammatical variants are intended to be non-limiting, such that recitation of items in a list is not to the exclusion of other like items that can be substituted or added to the listed items.

For the purposes of this specification and claims, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range. In addition, as used herein, the term “about”, when referring to a value can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed compositions and methods. Where particular values are described in the application and claims, unless otherwise stated, the term “about” meaning within an acceptable error range for the particular value should be assumed.

The terms “biopesticide” and “pesticide” are herein used interchangeably.

The present disclosure provides pesticide compositions having natural components that include various flavonoids and their derivatives such as, for example, baicalin, mangiferin, hesperidin, chitosan (an EPA approved adjuvant) and an antioxidant for application to plant foliage, plant roots, plant seeds, or the soil surrounding plants to kill or deter plant pests and pathogens including plant parasitic nematodes, root-eating coleoptera larvae, and fungi. In some embodiments, the pesticide compositions disclosed herein can be used in combination with another fungicide to enhance the fungicidal activity. Baicalin, swertiamarin and hesperidin are flavonoid derivatives extracted from barberry, chiretta and orange plants, respectively. These plant-based active ingredients are used in combinations herein to provide natural biocontrol formulations. The pesticide compositions can be formulated as a dry powder or as a flowable liquid. In various embodiments, the pesticide compositions are formulated with a cellulose-based polymer, such as hydroxyethyl cellulose either as a dry powder or as a flowable liquid such as, for example, an aqueous solution.

The pesticide composition provided herein that includes baicalin, glutathione, and chitosan can reduce the locomotion and kill root-knot nematodes within 10-45 seconds upon contact (see Example 1 herein below). This is an unexpected result given that when baicalin, glutathione, or chitosan are applied individually, nematodes are repelled, but the application is not fatal. Examples of the killing activity of a water-soluble formulation of the pesticide composition of the present disclosure is described in Example 1. This formulation can kill root knot Meloidogyne sp. nematodes within a few seconds of contact (see Table 1). In this example, the pesticide composition includes a ratio by weight of: (i) about 0.04% baicalin; (ii) about 0.05% water soluble chitosan; (iii) and about 0.02% by weight of L-glutathione.

In another experiment described in Example 1, each of the individual components of the pesticide formulation that includes baicalin, glutathione, and chitosan, and combinations of the individual components, were evaluated for an ability to repel and/or kill root knot nematodes. In this case, the pesticide composition was formulated as an aqueous solution with hydroxyethyl cellulose. Specifically, the pesticide composition includes a ratio by weight of: (i) about 0.04% baicalin; (ii) about 0.05% water soluble chitosan; (iii) about 0.02% by weight L-glutathione; and (iv) about 95% of a hydroxyethyl cellulose slurry in aqueous solution (Slurry Buddy 110 from Kannar Earth Science, Ltd.). The results of this evaluation on the nematodes is furnished in Table 2. Similar to the results shown in Table 1, the individual components and sub-combinations of components repelled but did not kill the nematodes. Only the formulation that contained each of baicalin, chitosan, and glutathione resulted in the death of the nematodes. The combination of baicalin, chitosan, and glutathione can provide a synergistic nematocidal activity.

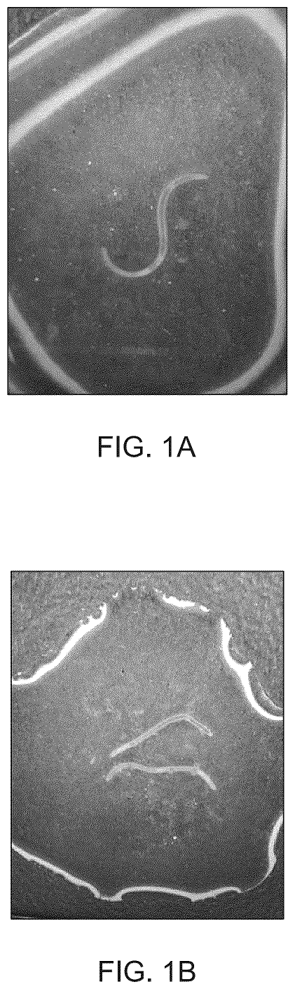

Additional experiments are described in which the nematode formulation with hydroxyethyl cellulose was stored and kept at room temperature (22° C.) for nine months and then tested again on live nematodes. In the test, which included three replicates of two live root knot nematodes, addition of the formulation instantly (18-30 seconds) killed all the nematodes. The rate of nematode fatality was one hundred percent upon contact with the nematicide formulation. A summary of the results of the three replicates of this experiment is shown in Table 3 and photographs are shown in FIGS. 1A and 1B.

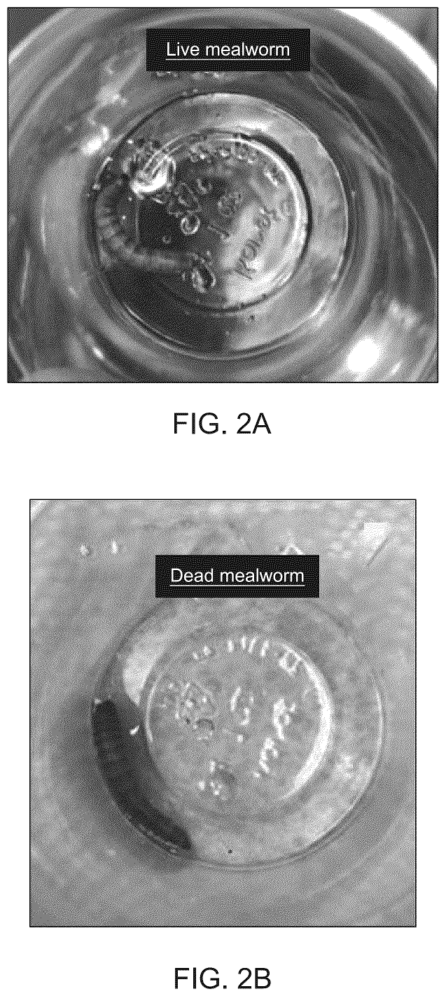

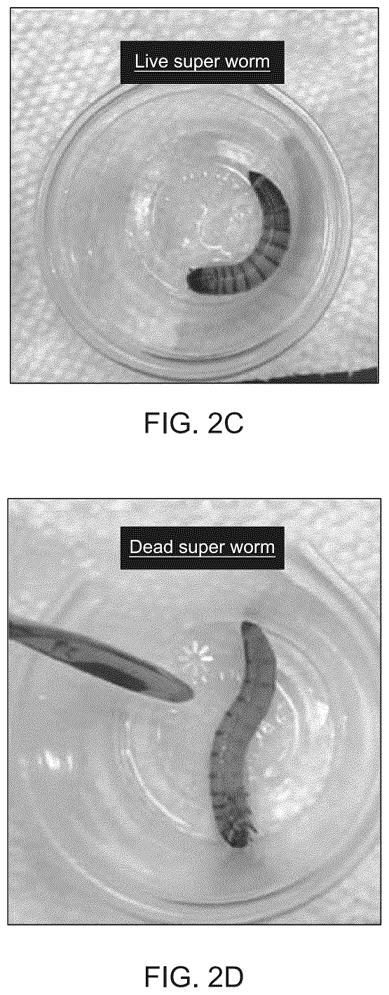

Example 2 of the present disclosure describes an experiment in which larvae of mealworms and kingworms were used as model organisms to represent corn rootworm and wireworms because they are all under the insect order, Coleoptera. These representative surrogate larvae were tested for mortality using a cup assay. When 1-2 ml of the pesticide composition including baicalin, chitosan, and L-glutathione in hydroxyethyl cellulose as described above was applied on the larvae surface, both mealworms and kingworms reacted to the formulation at point of contact and eventually died within 3-25 minutes (see Table 4, FIGS. 2A-2D). The mode of action for this fatality has yet to be deciphered. It was clear from visual observation that the fatality was not due to ingestion of the liquid applied, rather it was due to sensitization and reaction on their body surface.

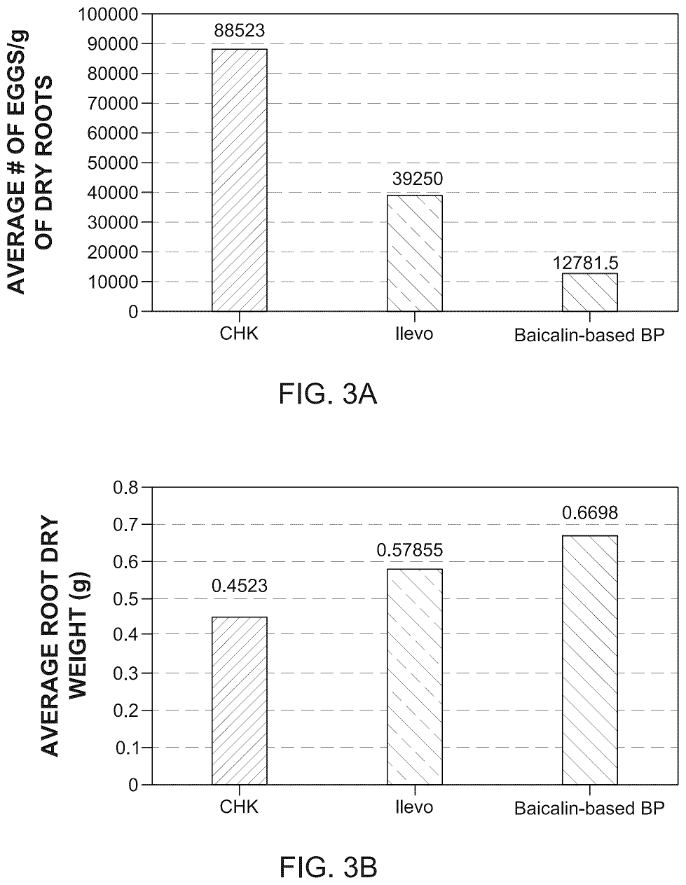

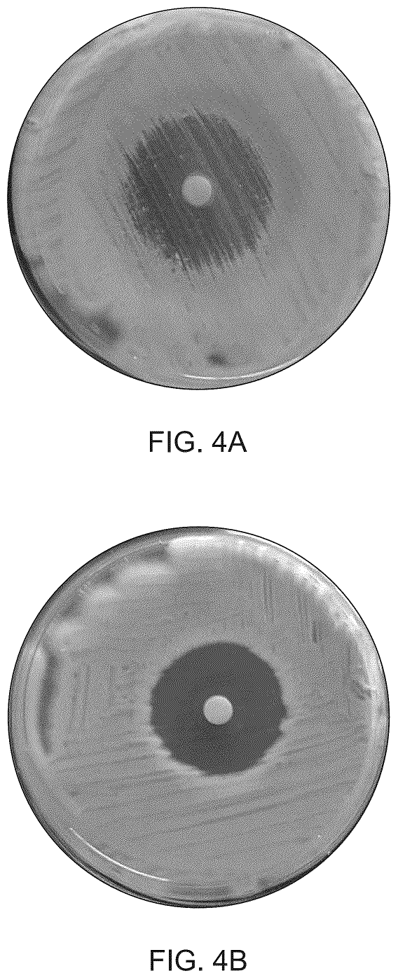

In addition to the nematocidal and pesticidal activities described above, the pesticide composition including baicalin, chitosan, and L-glutathione in hydroxyethyl cellulose as described above can provide antifungal activity. An experiment is described in Example 3 where the pesticide composition was added to a Petri plate containing the fungal pathogen Fusarium oxysporum, known to cause fusarium wilt to seedlings and mature plants. A comparison of the Zone of Inhibition (ZOI) between commercial chemical fungal pesticide (UPL's Rancona VPD) and the pesticide composition of the present disclosure is provided in Table 5 and FIGS. 3A-3B. The ZOI between the two are comparable demonstrating the antifungal activity of the pesticide composition. Example 4 describes an experiment where peanut seeds were treated with either the commercial chemical fungicide Rancona VPL (UPL, Ltd.) alone or treated with Rancona VPL in combination with the pesticide composition including baicalin, chitosan, and L-glutathione in hydroxyethyl cellulose as described above and the effects on seed germination and growth were evaluated. The results show that addition of the pesticide composition provided herein to Rancona VPL enhanced antifungal activity and improved germination and root growth (see FIGS. 4A & 4B).

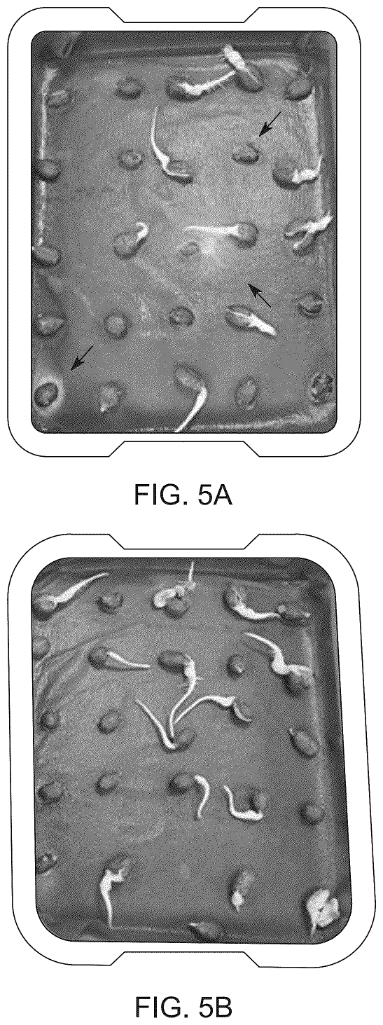

Example 5 describes an experiment in which a liquid formulation of the pesticide composition including baicalin, chitosan, and glutathione in hydroxyethyl cellulose was combined with a commercially available pesticide (containing ipconazole, carboxin and metalaxyl) to control fungal and bacterial growth on peanut seed during germination. The results of the experiment is shown in FIGS. 5A and 5B. FIGS. 5A and 5B These figures are photographs showing peanut seeds treated with UPL, Ltd.'s Rancona VPL pesticide (A) or Rancona VPL pesticide in combination with the formulation containing baicalin, chitosan, and glutathione (B). Addition of the formulation in combination with VPL pesticide showed better control of contamination (see arrows pointing to contamination in the tray in A) and better seedling germination and early root growth as can be seen in the tray in B.

Example 6 describes an experiment in which liquid formulations of biopesticide compositions of the present disclosure including antioxidant mangiferin, either with swertiamarin or hesperidin, and also including chitosan and glutathione in hydroxyethyl cellulose as described above were used to treat needle (Longidorus sp.) nematodes. Treatment of needle nematodes with the mangiferin and swertiamarin-based formulation as well as the mangiferin and hesperidin-based formulation were significantly more effective and quicker at killing the nematodes than formulations that included only mangiferin or swertiamarin. Thus, the pesticide compositions of the present disclosure that include a combination of mangiferin with swertiamarin or with hesperidin can result in synergistic killing of nematodes.

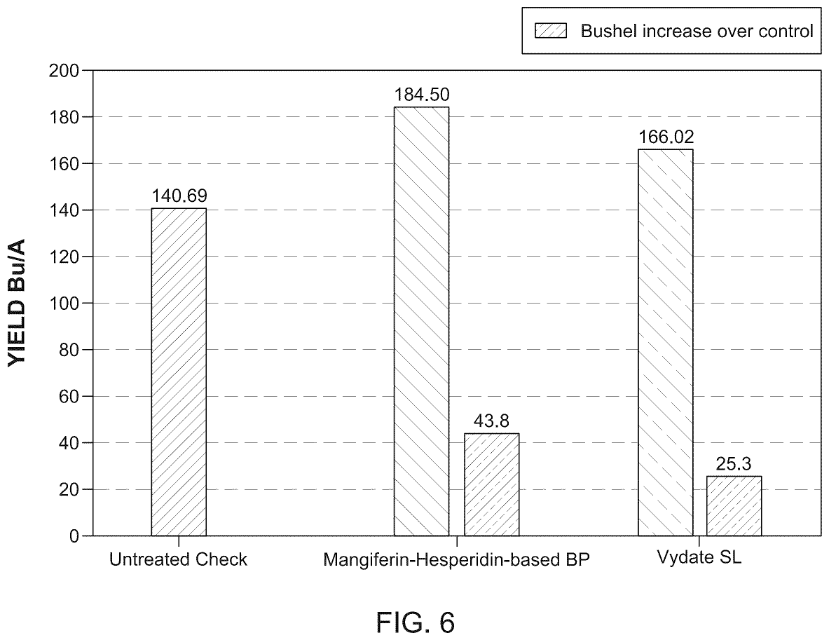

Example 7 describes a corn field trial conducted with the mangiferin-hesperidin based biopesticide formulation of the present disclosure as compared to UPL's Vydate SL synthetic nematicide applied to soil in-furrow. FIG. 6 is a graph showing corn yield enhancement in the field trial by the mangiferin-hesperidin-based composition of the present disclosure as compared to the industry-standard synthetic nematicide Vydate SL. The yield increase for the mangiferin-hesperidin-based composition of the present disclosure was 43.8 bu/A over control and 18.5 bu/A over Vydate SL.

In one embodiment, a pesticide composition is provided that includes (i) baicalin; (ii) chitosan; and (iii) glutathione. The components (i)-(iii) can be present in the composition in an amount suitable to improve one or both of plant growth and health in the presence of one or more plant pathogens. Plant pathogens include, but are not limited to, nematodes, rootworms, and fungi. In some cases, the components (i)-(iii) in the composition are present in an amount sufficient to provide synergistic activity against nematodes.

The pesticide composition of the present disclosure can include an amount of component (i) baicalin in the range from 0.1 to 1.00 g/L, an amount of component (ii) chitosan in the range from 0.1 to 1.0 g/L, and an amount of component (iii) glutathione in the range from 0.1 to 1.0 g/L.

The pesticide composition of the present disclosure can be formulated as a dry powder, and in some embodiments the components (i)-(iii) in the composition are present in a ratio by weight of: (i) about 0.02 to about 0.08% baicalin; (ii) about 0.025 to about 0.1% chitosan; and (iii) about 0.01 to about 0.04% glutathione.

In another embodiment, a pesticide composition is provided that includes (i) mangiferin, (ii) swertiamarin, (iii) chitosan, and (iv) glutathione. The components (i)-(iv) are present in the composition in an amount suitable to improve one or both of plant growth and health in the presence of one or more plant pathogens. The components (i)-(iv) can be present in the composition in a ratio by weight of: (i) about 0.01 to about 0.1% mangiferin; (ii) about 0.01 to about 0.05% swertiamarin; (iii) about 0.05 to about 0.1% chitosan; and (iv) about 0.01 to about 0.04% glutathione.

In yet another embodiment, a pesticide composition is provided that includes (i) mangiferin, (ii) hesperidin, (iii) chitosan, and (iv) glutathione. The components (i)-(iv) are present in the composition in an amount suitable to improve one or both of plant growth and health in the presence of one or more plant pathogens. The components (i)-(iv) can be present in the composition in a ratio by weight of: (i) about 0.02 to about 0.1% mangiferin; (ii) about 0.02 to about 0.1% hesperidin; (iii) about 0.025 to about 0.1% chitosan; and (iv) about 0.01 to about 0.04% glutathione.

The compositions of the present disclosure can be formulated as a dry powder or as a flowable liquid.

The compositions of the present disclosure can further include a cellulose-based polymer. The cellulose-based polymer can include hydroxyethycellulose.

In addition to the ready to use (RTU) compositions described above, the present disclosure also includes concentrated versions of these compositions that can be diluted with water prior to use. By way of non-limiting example, the compositions can be provided as 2-fold, 5-fold, 10-fold, 50-fold, 100-fold or more concentrates for dilution to the RTU concentration prior to use.

In another embodiment, a plant seed is provided that is coated with a composition of the present disclosure, wherein the components are present in the composition on the coated seed in an amount suitable to improve one or both of plant growth and health in the presence of one or more plant pathogens. The composition can include: (i) baicalin, or mangeferin and swertiamarin, or mangiferin and hesperidin; (ii) chitosan; and (iii) glutathione, wherein the components (i)-(iii) are present in the composition on the coated seed in an amount suitable to improve one or both of plant growth and health in the presence of one or more plant pathogens. The components (i)-(iii) can be present in the composition on the coated seed in a ratio by weight of: (a) about 0.02 to about 0.08% baicalin, about 0.025 to about 0.1% chitosan; and about 0.01 to about 0.04% glutathione; (b) about 0.01 to about 0.1% mangiferin, about 0.01 to about 0.05% swertiamarin, about 0.05 to about 0.1% chitosan, and about 0.01 to about 0.04% glutathione; or (c) about 0.02 to about 0.1% mangiferin, about 0.02 to about 0.1% hesperidin, about 0.025 to about 0.1% chitosan, and about 0.01 to about 0.04% glutathione.

In various instances, a method is provided of plant seed treatment including: applying to seeds of a plant a coating of a composition of the present disclosure, wherein the components are present in the composition on the coated seed in an amount suitable to improve one or both of plant growth and health in the presence of one or more plant pathogens. The composition can include: (i) baicalin, or mangeferin and swertiamarin, or mangiferin and hesperidin; (ii) chitosan; and (iii) glutathione, wherein the components (i)-(iii) are present in the composition on the coated seed in an amount suitable to improve one or both of plant growth and health in the presence of one or more plant pathogens. The components (i)-(iii) can be present in the composition on the coated seed in a ratio by weight of: (a) about 0.02 to about 0.08% baicalin, about 0.025 to about 0.1% chitosan; and about 0.01 to about 0.04% glutathione; (b) about 0.01 to about 0.1% mangiferin, about 0.01 to about 0.05% swertiamarin, about 0.05 to about 0.1% chitosan, and about 0.01 to about 0.04% glutathione; or (c) about 0.02 to about 0.1% mangiferin, about 0.02 to about 0.1% hesperidin, about 0.025 to about 0.1% chitosan, and about 0.01 to about 0.04% glutathione.

In other instances, a method is provided for improving plant growth and/or health including: planting a plant or a seed of a plant in a suitable growth medium, the plant or the seed having a coating or partial coating of a composition of the present disclosure, wherein the components are present in the composition on the coated plant or seed in an amount suitable to improve one or both of plant growth and health in the presence of one or more plant pathogens. The composition can include: (i) baicalin, or mangeferin and swertiamarin, or mangiferin and hesperidin; (ii) chitosan; and (iii) glutathione, wherein the components (i)-(iii) are present in the composition on the coated plant or seed in an amount suitable to improve one or both of plant growth and health in the presence of one or more plant pathogens. The components (i)-(iii) can be present in the composition on the plant or the seed in a ratio by weight of: (a) about 0.02 to about 0.08% baicalin, about 0.025 to about 0.1% chitosan; and about 0.01 to about 0.04% glutathione; (b) about 0.01 to about 0.1% mangiferin, about 0.01 to about 0.05% swertiamarin, about 0.05 to about 0.1% chitosan, and about 0.01 to about 0.04% glutathione; or (c) about 0.02 to about 0.1% mangiferin, about 0.02 to about 0.1% hesperidin, about 0.025 to about 0.1% chitosan, and about 0.01 to about 0.04% glutathione.

In some embodiments, a method is provided for improving plant growth and/or health including: delivering to seed of a plant, foliage of a plant, roots of a plant, or soil or growth medium surrounding a plant, a composition of the present disclosure, wherein the components are present in the composition in an amount suitable to improve one or both of plant growth and health in the presence of one or more plant pathogens. The composition can include: (i) baicalin, or mangeferin and swertiamarin, or mangiferin and hesperidin; (ii) chitosan; and (iii) glutathione, wherein the components (i)-(iii) are present in the composition in an amount suitable to improve one or both of plant growth and health in the presence of one or more plant pathogens. The components (i)-(iii) can be present in the composition in a ratio by weight of: (a) about 0.02 to about 0.08% baicalin, about 0.025 to about 0.1% chitosan; and about 0.01 to about 0.04% glutathione; (b) about 0.01 to about 0.1% mangiferin, about 0.01 to about 0.05% swertiamarin, about 0.05 to about 0.1% chitosan, and about 0.01 to about 0.04% glutathione; or (c) about 0.02 to about 0.1% mangiferin, about 0.02 to about 0.1% hesperidin, about 0.025 to about 0.1% chitosan, and about 0.01 to about 0.04% glutathione.

In various embodiments, the one or more plant pathogens can be, but are not limited to, one or a combination of nematodes, fungi, or rootworms.

In one instance, the components in the compositions of the present disclosure are present in an amount sufficient to provide synergistic activity against nematodes.

In other embodiments, the seed or plant can include a monocot or a dicot. The seed or plant can include, but is not limited to, corn, soybean, cotton, peanut, wheat, rice, sorghum, canola, chickpea, lentil, potato, tomato, eggplant, cucumber, or squash. The seed or plant can include a legume or a non-legume.

The present invention will be described in more detail below through examples, but these examples are not intended to limit the present disclosure.

### EXAMPLES

### Example 1

### Pesticide Composition Kills Nematodes within Seconds of Contact

Live root knot nematodes were collected from soil and kept in shallow water in small glass beakers at room temperature. The individual components and combined formulation were prepared according to the following procedures.

Aqueous solutions of individual components were prepared at the concentrations as follows: 400 ppm baicalin (95% purity; Shaanxi Darwin Biotech Co, China), 500 ppm water soluble chitosan (85% purity; Shaanxi Rainwood Biotech Co Ltd, China) and 200 ppm L-glutathione (99% purity; Hunan Insen Biotech Co Ltd, China). Since use of liquid polymer is quite common in seed treatment for better and smoother coating or coverage, each of the individual components and combinations of the components was also prepared as a solution in a cellulose-based carrier (Slurry Buddy 110 from Kannar Earth Science, Ltd.). Baicalin was dissolved in 1.0 ml of DMSO separately prior to addition to the carrier. Chitosan and glutathione were dissolved in 7.8 ml water prior to addition to the 90.0 ml carrier. In each case, the pH of the solution was adjusted to 5.7. The final aqueous formulation in cellulose-based polymer included: (i) about 0.04% baicalin; (ii) about 0.05% water soluble chitosan; (iii) about 0.02% by weight L-glutathione; (v) about 1% by weight of DMSO; and (vi) about 95% of an aqueous solution of a cellulose-based polymer. This liquid flowable formulation can be used as a ready-to-use (RTU) formulation for seed application.

The effect of the components individually and the three components combined was tested on live root-knot nematodes as follows. An individual nematode was placed in a watch glass (55 mm) containing 2 ml water and kept under a digital inspection microscope (TAGARNO). One drop of the water-based solutions described above was added to the watch glass with the swimming nematode and the reaction of the nematode was recorded for a period of two-minutes. This procedure was repeated 4 to 7 times for each of the individual components and for the combination of all components (i.e., the formulation). The results are summarized in Table 1. Each of the components baicalin, chitosan, and glutathione, when applied alone exhibited strong reactions by the nematodes via faster locomotion and swimming away from the point of application in the measured two-minute period. This reaction appeared to be a repellent effect. The formulation including all three components instantly (10-45 seconds) killed the nematode (see Table 1). This was an unexpected synergistic effect given that none of the individual components alone killed the nematodes.

Another experiment was performed as described above where the individual components and sub-combinations of the components were prepared as a liquid cellulose-based formulation as described above. The data are shown in Table 2. Like the results described above, the individual components and sub-combinations of components repelled but did not kill the nematodes. Only the formulation that contained each of baicalin, chitosan, and glutathione resulted in the death of the nematodes (see Table 2). Thus, the combination of baicalin, chitosan, and glutathione can provide a synergistic nematocidal activity.

TABLE 1
Two-minute contact with live nematodes for each individual
component or the combined components in water-based
formulation. Fatality recorded within 45 seconds.

| Nematode | | | | Gluta- | All |
|---|---|---|---|---|---|
| Status | Water | Baicalin | Chitosan | thione | Combined |
| Number of live | 3 | 4 | 8 | 3 | 3 |
| nematodes | | | | | |
| Nematode | None | Repelling | Repelling | Repelling | Dead |
| Reaction | | | | | |

TABLE 2
Two-minute contact with live adult nematodes for various components
in combinations in liquid polymer-based formulation

| | Number | Number of | |
|---|---|---|---|
| | of live | Nematodes | Number of |
| | Root Knot | repelled | Dead |
| Components | Nematodes | or reacted | Nematodes |
| Carrier, Slurry Buddy 110 | 5 | 5 | 0 |
| Carrier + Baicalin | 5 | 5 | 0 |
| Carrier + Chitosan | 5 | 5 | 0 |
| Carrier + Glutathione | 5 | 6 | 0 |
| Carrier + Baicalin + Chitosan | 4 | 4 | 0 |
| Carrier + Baicalin + | 5 | 0 | 5 |
| Chitosan + Glutathione | | | |

The liquid cellulose-based formulation described above containing baicalin, chitosan, and glutathione was stored and kept at room temperature (22° C.) for nine months and then tested again on live nematodes. In the test, there were three replicates indicated as Plate#1, Plate#2 and Plate#3, each containing a certain number of live root-knot nematodes swimming in water in watch glass. A drop or two of the formulation was added to the swimming nematodes, which instantly (10-30 seconds) killed all the nematodes (see FIGS. 1A-1B). The rate of nematode fatality was 100% upon contact with the nematicide formulation. A summary of the results of the three replicates of this experiment is shown in Table 3 below. The formulation repeatedly killed the root-knot nematodes at time of contact (within 10-30 seconds).

TABLE 3
Effect of a pesticide composition containing baicalin, chitosan,
and glutathione on the number of nematodes in glass plate

| | No. of RKN | Application | Death time |
|---|---|---|---|
| Replication | nematodes | rate/plate | (seconds) |
| Plate#1 | 2 | 1 ml | 25 |
| Plate#2 | 2 | 1 ml | 21 |
| Plate#3 | 3 | 1 ml | 18 |

### Example 2

### Pesticide Composition Kills Insect Larvae

An experiment was conducted to investigate the response of the formulation containing baicalin, chitosan, and glutathione when applied directly on insect larvae body surface. Mealworms and Kingworms (also known as Superworms) were purchased from a local pet store. An individual mealworm or superworm was kept in small plastic cup and a drop, approximately 1.0 ml of the liquid formulation, was applied on the worm. A prompt reaction was noticed as soon as the worms encountered the liquid. The worms were motile for some moments but succumbed to death within 3-18 minutes (see Table 4). Mealworms are smaller in size than superworms and their fatality was faster than superworms (FIGS. 2A-2D).

TABLE 4
Cup Assay for mortality testing

| | | # of | Application | | |
|---|---|---|---|---|---|
| Replication | Worm Type | Live worms | rate/cup | Mortality Time | |
| Cup#1 | Mealworm | 2 | 1 ml | 3 | minutes |
| Cup#2 | Mealworm | 2 | 1 ml | 3.5 | minutes |
| Cup#3 | Mealworm | 3 | 2 ml | 5 | min |
| Cup#1 | Kingworm | 1 | 1 ml | 25 | min |
| Cup#2 | Kingworm | 1 | 2 ml | 18 | min |
| Cup#3 | Kingworm | 1 | 3 ml | 16 | min |

### Example 3

### Greenhouse Pot Assay for Root Knot Nematode Control

A greenhouse pot assay was conducted by the University of Arkansas, Nematode Diagnostic Lab, Southwest Research and Extension Center. Soybean variety DG4880 was grown in 4″ clay pots with 90/10 sand:loam mix. Root knot nematode eggs were added to the pot when soybean seedlings had their 1^{st} true leaves. Pots were arranged in a randomized block design with 4 replicates (or pots) per treatment. Nematodes were counted after 62 days of planting. Bayer's Ilevo synthetic nematicide was used as a positive control.

FIGS. 3A and 3B show the effect of the baicalin-based biopesticide formulation on the control of soybean root knot nematodes and plant root dry biomass. The greenhouse pot assay demonstrated a reduction of the number of RKN by Bayer's Ilevo at their recommended rate (FIG. 3A). However, the baicalin-based biopesticide formulation of the present invention applied at a rate proportional to 1.0 gallon/acre showed significantly lower (0.1%) RKN egg numbers than Ilevo (FIG. 3A). The data in FIG. 3B show that at harvest, soybean root dry biomass was higher for each of the treated pots than the negative control, but these results were not statistically significant.

### Example 4

### Anti-Fungal Activity of Pesticide Composition

The anti-fungal activity of the baicalin-based biopesticide formulation of the present disclosure was tested against a very pathogenic fungus Fusarium oxysporum, notoriously known for wilting of seedlings and mature plants, particularly but not entirely of the solanaceous family. Fungal sample was purchased from Carolina Biological Supply Company, 2700 York Road, Burlington, NC 27215, Item #156033). Antimicrobial tests were performed using a disc diffusion method on potato dextrose agar (PDA). The diffusion disc of the sample with 6 mm diameter was placed onto an agar Petri plate that had been inoculated with F. oxysporum and kept incubated at 30° C. After 48 h, clear or Zones of Inhibition (ZOI) were measured in mm. A comparison of the ZOI zones between commercial fungal pesticide (UPL's Rancona V PD with percent by weight active ingredients: ipconazole 1%, carboxin 16%, and metalaxyl 0.8%) and a pesticide composition of the present disclosure including baicalin, chitosan, and glutathione is shown in Table 5 and FIGS. 4A-4B. FIG. 4A is a photograph showing antifungal (F. oxysporum) activity represented by zone of inhibition (ZOI) on a Petri plate for commercial pesticide Rancona V PD (UPL, Ltd.). FIG. 4B is a photograph showing antifungal (F. oxysporum) activity represented by zone of inhibition (ZOI) on a Petri plate for a pesticide composition of the present invention including baicalin, chitosan, and glutathione. The results demonstrate comparable control of Fusarium by the pesticide composition of the presence to the commercially available synthetic pesticide.

TABLE 5
Zone of Inhibition (in mm) of F. oxysporum

| Replication | Rancona VPD (A) | Current formulation |
|---|---|---|
| 1 | 32 | 30 |
| 2 | 32 | 30 |
| 3 | 33 | 32 |
| 4 | 34 | 29 |
| Average | 32.75 | 30.25 |

### Example 5

### Pesticide Composition Enhances Anti-Fungal Activity of Commercial Pesticide and Improves Plant Growth

In this example, a liquid formulation of the pesticide composition containing baicalin, chitosan, and glutathione in hydroxyethyl cellulose as described above was combined with a commercially available pesticide to control fungal and bacterial growth on peanut seed during germination. UPL, Ltd.'s Rancona V PL pesticide blend containing ipconazole, carboxin and metalaxyl, either alone or mixed with the liquid formulation was used to treat peanut seeds from Tifton Peanut Company. Seeds were placed in a germination seed tray on moist germination paper. Seed germination trays were covered by lids and kept at room temperature (22° C.) in the dark. Seed germination, contamination, and seedling root growth was documented by photograph (FIGS. 5A-5B). FIGS. 5A-5B are photographs showing peanut seeds treated with UPL, Ltd.'s Rancona VPL pesticide (A) or Rancona VPL pesticide in combination with the formulation containing baicalin, chitosan, and glutathione (B). Addition of the formulation in combination with VPL pesticide showed better control of contamination (see arrows pointing to contamination in the tray in A) and better seedling germination and early root growth as can be seen in the tray in B.

### Example 6

### Pesticide Compositions Exhibit Nematicidal Activity

In this example, liquid formulations of biopesticide compositions containing antioxidant mangiferin, either with swertiamarin or hesperidin, and also including chitosan and glutathione in hydroxyethyl cellulose as described above were used to treat needle (Longidorus sp.) nematodes. Individual needle nematodes were taken on small watch glass in 2 ml water and 1 ml of the formulation was added to evaluate the mortality rate under a RAGARNO magnification screen system. The time of killing of needle nematodes was very quick, within 25-50 seconds (see Table 6).

TABLE 6
Mortality of needle nematodes upon
exposure to liquid formulations

| | | | Number of |
|---|---|---|---|
| | Number | Number of | Dead |
| | of live | Nematodes | Nematodes |
| | Needle | repelled | within 25-50 |
| Components | Nematodes | or reacted | seconds |
| Carrier, Slurry Buddy 110 | 10 | 10 | 1 |
| Carrier + Mangeferin | 8 | 8 | 3 |
| Carrier + Swertiamarin | 8 | 8 | 1 |
| Carrier + Mangeferin + | 8 | 8 | 8 |
| Swertiamarin | | | |
| Carrier + Hesperidin | 6 | 6 | 0 |
| Carrier + Mangiferin + | 10 | 10 | 10 |
| Hesperidin | | | |

It was noted that treatment of needle nematodes with mangiferin and swertiamarin-based formulation as well as mangiferin and hesperidin-based formulation were significantly more effective and quicker at killing the nematodes than their individual formulation. These data indicate that the combination of mangiferin with swertiamarin or hesperidin results in synergistic killing of nematodes.

### Example 7

### Corn Field Trial with Nematicide formulation as Compared to Synthetic Nematicide Vydate SL

A corn field trial was conducted in South Africa with the mangiferin-hesperidin based biopesticide formulation of the present disclosure as compared to UPL' s Vydate SL synthetic nematicide. The corn trial was executed using 4 replicated small field plots using a randomized block design. The application of nematicides was soil applied in-furrow. FIG. 6 is a graph showing corn yield enhancement in the field trial by the mangiferin-hesperidin-based composition of the present disclosure (Mangiferin-Hesperidin-based BP) as compared to the industry-standard synthetic nematicide Vydate SL (Vydate SL) and untreated control (Untreated Check). The yield increase was 43.8 bu/A over control and 18.5 bu/A over Vydate SL.

One skilled in the art will readily appreciate that the present disclosure is well adapted to carry out the objects and obtain the ends and advantages mentioned, as well as those inherent therein. The present disclosure is representative of embodiments, which are exemplary, and are not intended as limitations on the scope of the present disclosure. Changes and other uses will occur to those skilled in the art which are encompassed within the spirit of the present disclosure as defined by the scope of the claims.

No admission is made that any reference, including any non-patent or patent document cited in this specification, constitutes prior art. It will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references

What is claimed is:

1. A pesticide composition comprising:
(i) baicalin, or mangeferin and swertiamarin, or mangiferin and hesperidin;
(ii) chitosan; and
(iii) glutathione,
wherein the components are present in the composition in an amount suitable to improve one or both of plant growth and health in the presence of one or more plant pests or pathogens.

2. The composition of claim 1, wherein the components (i)-(iii) are present in the composition in a ratio by weight of:
(i) about 0.02 to about 0.08% baicalin, about 0.025 to about 0.1% chitosan; and about 0.01 to about 0.04% glutathione;
(ii) about 0.01 to about 0.1% mangiferin, about 0.01 to about 0.05% swertiamarin, about 0.05 to about 0.1% chitosan, and about 0.01 to about 0.04% glutathione; or
(iii) about 0.02 to about 0.1% mangiferin, about 0.02 to about 0.1% hesperidin, about 0.025 to about 0.1% chitosan, and about 0.01 to about 0.04% glutathione.

3. The composition of claim 1, formulated as a dry powder or as a flowable liquid.

4. The composition of claim 1, wherein the composition further comprises a cellulose-based polymer.

5. The composition of claim 1, wherein the one or more plant pests or pathogens comprises one or a combination of nematodes, fungi, or rootworms.

6. A plant seed coated with a composition comprising:
(i) baicalin, or mangeferin and swertiamarin, or mangiferin and hesperidin;
(ii) chitosan; and
(iii) glutathione,
wherein the components (i)-(iii) are present in the composition on the coated seed in an amount suitable to improve one or both of plant growth and health in the presence of one or more plant pests or pathogens.

7. The plant seed of claim 6, wherein the composition comprises the components (i)-(iii) in a ratio by weight of:
a) about 0.02 to about 0.08% baicalin, about 0.025 to about 0.1% chitosan; and about 0.01 to about 0.04% glutathione;
b) about 0.01 to about 0.1% mangiferin, about 0.01 to about 0.05% swertiamarin, about 0.05 to about 0.1% chitosan, and about 0.01 to about glutathione; or
c) about 0.02 to about 0.1% mangiferin, about 0.02 to about 0.1% hesperidin, about 0.025 to about 0.1% chitosan, and about 0.01 to about 0.04% glutathione.

8. The seed of claim 6, wherein the composition further comprises a cellulose-based polymer.

9. The seed of claim 6, wherein the one or more plant pests or pathogens comprises one or a combination of nematodes, fungi, or rootworms.

10. The seed of claim 6, wherein the seed comprises a monocot or a dicot.

11. The seed of claim 6, wherein the seed comprises corn, soybean, cotton, peanut, wheat, rice, sorghum, canola, chickpea, lentil, potato, tomato, eggplant, cucumber, or squash.

12. The seed of claim 6, wherein the seed comprises a legume.

13. The seed of claim 6, wherein the seed comprises a non-legume.

14. A method of plant seed treatment comprising applying to seeds of a plant a coating of a composition comprising:
(i) baicalin, or mangeferin and swertiamarin, or mangiferin and hesperidin;
(ii) chitosan; and
(iii) glutathione,
wherein the components (i)-(iii) are present in the composition on the seed in an amount suitable to improve one or both of plant growth and health in the presence of one or more plant pests or pathogens.

15. The method of claim 14, wherein the composition comprises the components (i)-(iii) in a ratio by weight of:
a) about 0.02 to about 0.08% baicalin, about 0.025 to about 0.1% chitosan; and about 0.01 to about 0.04% glutathione;
b) about 0.01 to about 0.1% mangiferin, about 0.01 to about 0.05% swertiamarin, about 0.05 to about 0.1% chitosan, and about 0.01 to about 0.04% glutathione; or
c) about 0.02 to about 0.1% mangiferin, about 0.02 to about 0.1% hesperidin, about 0.025 to about 0.1% chitosan, and about 0.01 to about 0.04% glutathione.

16. The method of claim 14, wherein the composition further comprises a cellulose-based polymer.

17. The method of claim 14, wherein the one or more plant pests or pathogens comprises one or a combination of nematodes, fungi, or rootworms.

18. The method of claim 14, wherein the seed comprises corn, soybean, cotton, peanut, wheat, rice, sorghum, canola, chickpea, lentil, potato, tomato, eggplant, cucumber, or squash.

19. The method of claim 14, wherein the seed comprises a legume.

20. The method of claim 14, wherein the seed comprises a non-legume.
